(19) United States
(12) Patent Application Publication
(10) Pub. No.: US 2007/0233886 A1
(43) Pub. Date: Oct. 4, 2007

(54) Method and system for a one bit TCP offload

(76) Inventor: Kan Frankie Fan, Diamond Bar, CA (US)

Correspondence Address: MCANDREWS HELD & MALLOY, LTD, 500 WEST MADISON STREET, SUITE 3400, CHICAGO, IL, 60661, US

(21) Appl. No.: 11/434,972

(22) Filed: May 16, 2006

Related U.S. Application Data
(60) Provisional application No. 60/789,034, filed on Apr. 4, 2006.

(51) Int. Cl. G06F 15/16

(52) U.S. Cl. 709/230

(57) ABSTRACT

Certain aspects of a method and system for a one bit TCP offload may comprise initiating offload processing of TCP data based on assertion of at least one bit without receiving TCP connection state information from a host. The asserted at least one bit of data may comprise at least one of: a synchronous (SYN) control bit and an acknowledgement (ACK) bit a received packet of data. A TCP passive connection lookup table (PCLT) may be checked utilizing at least one of: a source IP address, a destination IP address, a source TCP port, and a destination TCP port to determine whether the received packet of data comprising said asserted SYN control bit and said asserted ACK bit matches an entry in the PCLT.

### CROSS-REFERENCE TO RELATED APPLICATIONS/INCORPORATION BY REFERENCE

This patent application makes reference to, claims priority to and claims benefit from U.S. Provisional Patent Application Ser. No. 60/789,034, filed on Apr. 4, 2006.

The above reference application is hereby incorporated herein by reference in its entirety.

### FIELD OF THE INVENTION

Certain embodiments of the invention relate to networking systems. More specifically, certain embodiments of the invention relate to a method and system for a one bit transmission control protocol (TCP) offload.

### BACKGROUND OF THE INVENTION

Innovations in data communications technology, fueled by bandwidth-intensive applications, have led to a ten-fold improvement in networking hardware throughput occurring about every four years. These network performance improvements, which have increased from 10 Megabits per second (Mbps) to 100 Mbps, and now to 1-Gigabit per second (Gbps) with 10-Gigabit on the horizon, have outpaced the capability of central processing units (CPUs). To compensate for this dilemma and to free up CPU resources to handle general computing tasks, offloading Transmission Control Protocol/Internet Protocol (TCP/IP) functionality to dedicated network processing hardware is a fundamental improvement. TCP/IP offload maximizes utilization of host CPU resources for application workloads, for example, on Gigabit and multi-Gigabit networks.

TCP/IP offload provides a holistic technique for segmenting TCP/IP processing into tasks that may be handled by dedicated network processing controller hardware and an operating system (OS). TCP/IP offload redirects most of the TCP/IP related tasks to a network controller for processing, which frees up networking-related CPU resources overhead. This boosts overall system performance, and eliminates and/or reduces system bottlenecks. Additionally, TCP/IP offload technology will play a key role in the scalability of servers, thereby enabling next-generation servers to meet the performance criteria of today's high-speed networks such as Gigabit Ethernet (GbE) networks.

Although TCP/IP offload is not a new technology, conventional TCP/IP offload applications have been platform specific and were not seamlessly integrated with the operating system's networking stack. As a result, these conventional offload applications were standalone applications, which were platform dependent and this severely affected deployment. Furthermore, the lack of integration within an operating system's stack resulted in two or more independent and different TCP/IP implementations running on a single server, which made such systems more complex to manage.

TCP/IP offload may be implemented using a PC-based or server-based platform, an associated operating system (OS) and a TCP offload engine (TOE) network interface card (NIC). The TCP stack is embedded in the operating system of a host system. The combination of hardware offload for performance and host stack for controlling connections, results in the best OS performance while maintaining the flexibility and manageability of a standardized OS TCP stack. TCP/IP offload significantly boosts application performance due to reduced CPU utilization. Since TCP/IP offload architecture segments TCP/IP processing tasks between TOE's and an operating system's networking stack, all network traffic may be accelerated through a single TCP/IP offload compliant adapter, which may be managed using existing standardized methodologies. TCP offload may be utilized for wired and wireless communication applications.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and system for a one bit transmission control protocol (TCP) offload, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary system illustrating operation of a storage area network that may be utilized in connection with an embodiment of the invention.

FIG. 2 is a block diagram illustrating the software architecture in an initiator application that may be utilized in connection with an embodiment of the invention.

FIG. 3 is a block diagram of a network interface card (NIC) where a host system supports a plurality of group of operating systems (GOSs), in connection with an embodiment of the invention.

FIG. 4 is a block diagram illustrating offload of data from a host TCP processor to a TCP offload engine (TOE), in accordance with an embodiment of the invention.

FIG. 5 is a flowchart illustrating TCP offload during transmission of packets from host TCP stack, in accordance with an embodiment of the invention.

FIG. 6 is a flowchart illustrating TCP offload during receipt of packets by host TCP stack, in accordance with an embodiment of the invention.

FIG. 7 is a flowchart illustrating termination of a TCP offload connection, in accordance with an embodiment of the invention.

### DETAILED DESCRIPTION OF THE INVENTION

Certain aspects of a method and system for a one bit TCP offload may comprise initiating offload processing of TCP data based on assertion of at least one bit without receiving TCP connection state information from a host. The asserted at least one bit of data may comprise at least one of: a synchronous (SYN) control bit and an acknowledgement (ACK) bit a received packet of data. A TCP passive connection lookup table (PCLT) may be checked utilizing at least one of: a source IP address, a destination IP address, a source TCP port, and a destination TCP port to determine whether the received packet of data comprising said asserted SYN control bit and said asserted ACK bit matches an entry in the PCLT. The offload processing of the TCP data to the TCP offload engine may be terminated, if at least one of: a reset (RST) control bit and a finish (FIN) control bit is asserted in a received packet of data.

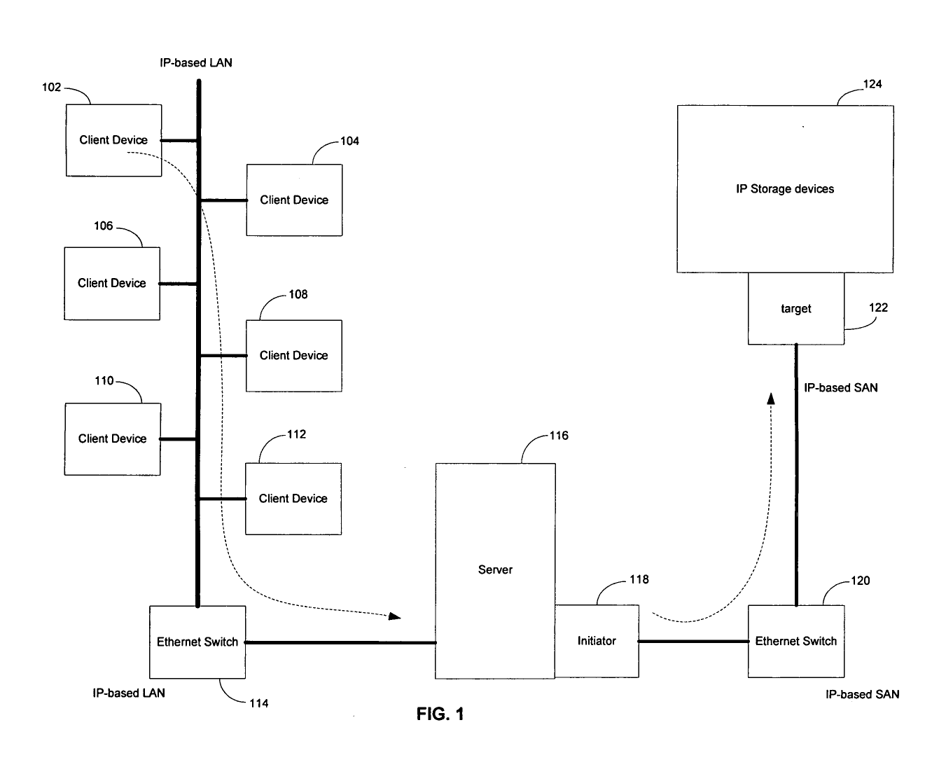

FIG. 1 is a block diagram of an exemplary system illustrating operation of a storage area network that may be utilized in connection with an embodiment of the invention. Referring to FIG. 1, there is shown a plurality of client devices 102, 104, 106, 108, 110 and 112, a plurality of Ethernet switches 114 and 120, a server 116, a initiator 118, a target 122 and a storage device 124.

The plurality of client devices 102, 104, 106, 108, 110 and 112 may comprise suitable logic, circuitry and/or code that may handle specific services from the server 116 and may be a part of a corporate traditional data-processing IP-based LAN, for example, to which the server 116 is coupled. The server 116 may comprise suitable logic and/or circuitry that may be coupled to an IP-based storage area network (SAN) to which IP storage device 124 may be coupled. The server 116 may process the request from a client device that may require access to specific file information from the IP storage devices 124. The Ethernet switch 114 may comprise suitable logic and/or circuitry that may be coupled to the IP-based LAN and the server 116. The initiator 118 may comprise suitable logic and/or circuitry that may enable receiving of specific commands from the server 116 and also enable encapsulation of these commands inside a TCP/IP packet(s) that may be embedded into Ethernet frames and sent to the IP storage device 124 over a switched or routed SAN storage network. The Ethernet switch 120 may comprise suitable logic and/or circuitry and may be coupled to the IP-based SAN and the server 116. The target 122 may comprise suitable logic, circuitry and/or code that may enable receiving an Ethernet frame, stripping at least a portion of the frame, and recovering the TCP/IP content. The target 122 may also enable decapsulation of the TCP/IP content, and enable obtaining of commands needed to retrieve the required information and forward the commands to the IP storage device 124. The IP storage device 124 may comprise a plurality of storage devices, for example, disk arrays or a tape library.

The client device, for example, client device 102 may request for a piece of information over the LAN to the server 116. The server 116 may be enable retrieval of the necessary information to satisfy the client request from a specific storage device on the SAN. The server 116 may then issue specific commands needed to satisfy the client device 102 and may pass the commands to the locally attached initiator 118. The initiator 118 may encapsulate these commands inside TCP/IP packet(s) that may be embedded into Ethernet frames and sent to the storage device 124 over a switched or routed storage network.

The target 122 may also be adapted to decapsulate the packet, and obtain the commands needed to retrieve the required information. The process may be reversed and the retrieved information may be encapsulated into TCP/IP segment form. This information may be embedded into one or more Ethernet frames and sent back to the initiator 118 at the server 116, where it may be decapsulated and returned as data for the command that was issued by the server 116. The server may then complete the request and place the response into the IP frames for subsequent transmission over a LAN to the requesting client device 102.

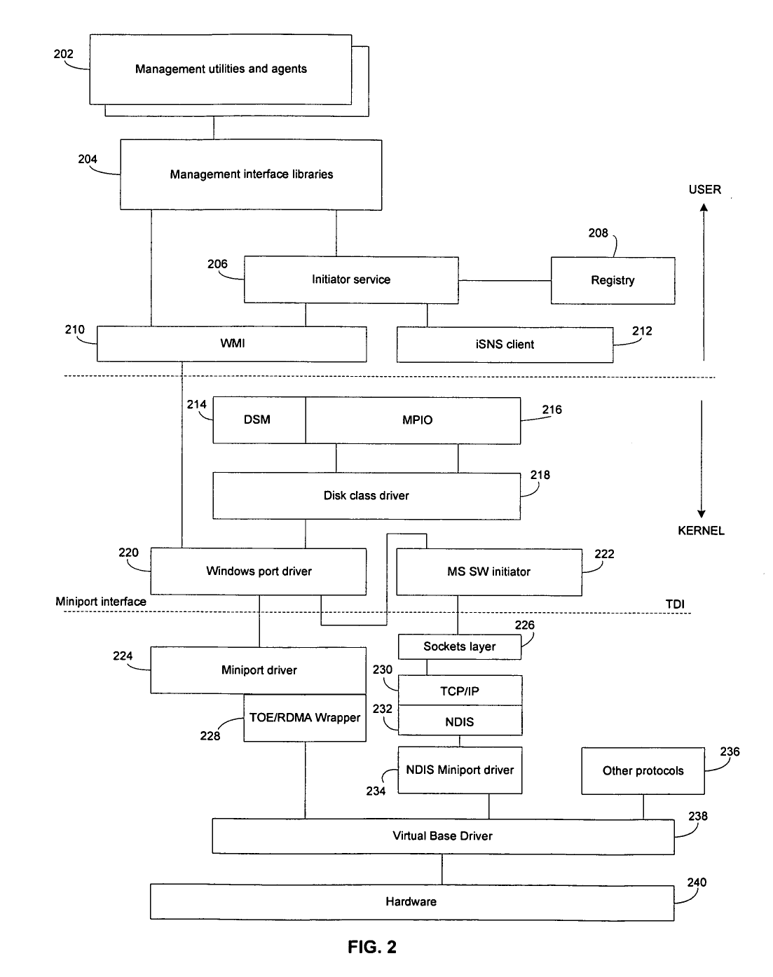

FIG. 2 is a block diagram illustrating the software architecture in an initiator application, in accordance with an embodiment of the invention. Referring to FIG. 2, there is shown a management utilities and agents block 202, a management interface libraries block 204, a initiator service block 206, a registry block 208, a Windows Management Instrumentation (WMI) block 210, an Internet Storage Name Service (iSNS) client block 212, a device specific module (DSM) block 214, a multi-path input output (MPIO) block 216, a disk class driver block 218, a Windows port driver block 220, a software initiator block 222, a sockets layer block 226, a TCP/IP block 230, a network driver interface specification (NDIS) block 232, a NDIS miniport driver block 234, a miniport driver block 224, a TCP offload engine (TOE)/remote direct memory access (RDMA) wrapper block 228, an other protocols block 236, a virtual bus driver block 238, and a hardware block 240. This diagram may be applicable to a target using the Microsoft Windows operating system, for example. For a target that utilizes another operating system, the hardware 240, the TCP/IP 230 and the target entity may replace the Microsoft SW initiator 222. While some of the components of FIG. 2 are native to the Microsoft Windows operating system, other operating systems may comprise similar functions. Accordingly, the invention is not limited to use of the Microsoft Windows operating system.

The management utilities and agents block 202 may comprise suitable logic, circuitry and/or code that may enable configuration of device management and control panel applications. The management interface libraries block 204 may comprise suitable logic, circuitry and/or code that may enable management and configuration of various interface libraries in the operating system. The management interface libraries block 204 may be coupled to the management utilities and agents block 202, the initiator service block 206 and the Windows Management Instrumentation (WMI) block 210. The initiator service block 206 may enable management of a plurality of initiators, for example, network adapters and host bus adapters on behalf of the operating system.

The initiator service block 206 may aggregate discovery information and manage security. The initiator service block 206 may be coupled to the management interface libraries block 204, the registry block 208, the iSNS client block 212 and the Windows Management Instrumentation (WMI) block 210. The registry block 208 may comprise a central hierarchical database that may utilized by an operating system, for example, Microsoft Windows 9x, Windows CE, Windows NT, and Windows 2000 to store information necessary to configure the system for one or more users, applications and hardware devices. The registry block 208 may comprise information that the operating system may reference during operation, such as profiles for each user, the applications installed on the computer and the types of documents that each may create, property sheet settings for folders and application icons, what hardware exists on the system, and the ports that are being used.

The Windows Management Instrumentation (WMI) block 210 may be adapted to organize individual data items properties into data blocks or structures that may comprise related information. Data blocks may have one or more data items. Each data item may have a unique index within the data block, and each data block may be named by a globally unique 128-bit number, for example, called a globally unique identifier (GUID). The WMI block 210 may provide notifications to a data producer as to when to start and stop collecting the data items that compose a data block. The Windows Management Instrumentation (WMI) block 210 may be further coupled to the Windows port driver block 220.

The Internet Storage Name Service (iSNS) client block 212 may comprise suitable logic, circuitry and/or code that may provide both naming and resource discovery services for storage devices on an IP network. The iSNS client block 212 may be adapted to build upon both IP and Fiber Channel technologies. The iSNS protocol may use an iSNS server as the central location for tracking information about targets and initiators. The iSNS server may run on any host, target, or initiator on the network. The iSNS client software may be required in each host initiator or storage target device to enable communication with the server. In an initiator, the iSNS client block 212 may register the initiator and query the list of targets. In a target, the iSNS client block 212 may register the target with the server.

The multi-path input output MPIO block 216 may comprise generic code for vendors to adapt to their specific hardware device so that the operating system may provide the logic necessary for multi-path I/O for redundancy in case of a loss of a connection to a storage target. The device specific module DSM block 214 may play a role in a number of critical events, for example, device-specific initialization, request handling, and error recovery. During device initialization, each DSM block 214 may be contacted in turn to determine whether or not it may provide support for a specific device. If the DSM block 214 supports the device, it may then indicate whether the device is a new installation, or a previously installed device which is now visible through a new path. During request handling, when an application makes an I/O request to a specific device, the DSM block 214 may determine based on its internal load balancing algorithms, a path through which the request should be sent. If an I/O request cannot be sent down a path because the path is broken, the DSM block 214 may be capable of shifting to an error handling mode, for example. During error handling, the DSM block 214 may determine whether to retry the input/output (I/O) request, or to treat the error as fatal, making fail-over necessary, for example. In the case of fatal errors, paths may be invalidated, and the request may be rebuilt and transmitted through a different device path.

The disk class driver block 218 may comprise suitable logic, circuitry and/or code that may receive application requests and convert them to commands, which may be transported in command description blocks (CDBs). The disk class driver block 218 may be coupled to the DSM block 214, the MPIO block 216, the Windows port driver block 220 and the software initiator block 222. In an operating system, for example, Microsoft Windows, there might be a plurality of paths where the networking stack may be utilized. The miniport driver 224 may interface with the hardware 240 in the same fashion as described above for the software initiator block 222. The TCP stack embedded in the TOE/RDMA wrapper 228 may be exposed to denial of service attacks and may be maintained. The interface between software initiator block 222 and the hardware 240 may also be adjusted to support iSCSI over RDMA known as iSCSI extensions for RDMA (iSER).

The Windows port driver block 220 may comprise a plurality of port drivers that may manage different types of transport, depending on the type of adapter, for example, USB, SCSI, iSCSI or Fiber Channel (FC) in use. The software initiator block 222 may function with the network stack, for example, iSCSI over TCP/IP and may support both standard Ethernet network adapters and TCP/IP offloaded network adapters. The software initiator block 222 may also support the use of accelerated network adapters to offload TCP overhead from a host processor to the network adapter. The miniport driver block 224 may comprise a plurality of associate device drivers known as miniport drivers. The miniport driver may enable implementation of routines necessary to interface with the storage adapter's hardware. A miniport driver may combine with a port driver to implement a complete layer in the storage stack. The miniport interface or the transport driver interface (TDI) may describe a set of functions through which transport drivers and TDI clients may communicate and the call mechanisms used for accessing them.

The software initiator block 222 or any other software entity that manages and owns the state or a similar entity for other operating systems may comprise suitable logic, circuitry and/or code that may enable reception of data from the Windows port driver 220 and offload it to the hardware block 240. On a target, the software target block may also support the use of accelerated network adapters to offload TCP overhead from a host processor to a network adapter.

The sockets layer 226 may be adapted to interface with the hardware 240 capable of supporting TCP offload. For non-offloaded TCP communication, the TCP/IP block 230 may utilize transmission control protocol/internet protocol that may provide communication across interconnected networks. The network driver interface specification NDIS block 232 may comprise a device-driver specification that may provide hardware and protocol independence for network drivers and offer protocol multiplexing so that multiple protocol stacks may coexist on the same host. The NDIS miniport driver block 234 may comprise routines that may be utilized to interface with the storage adapter's hardware and may be coupled to the NDIS block 232 and the virtual bus driver (VBD) block 238. The VBD 238 may be required in order to simplify the hardware 240 system interface and internal handling of requests from multiple stacks on the host.

The TOE/RDMA block 228 may comprise suitable logic, circuitry and/or code that may be adapted to implement remote direct memory access that may allow data to be transmitted from the memory of one computer to the memory of another computer without passing through either device's central processing unit (CPU). In this regard, extensive buffering and excessive calls to an operating system kernel may not be necessary. The TOE/RDMA block 228 may be coupled to the virtual bus driver block 238 and the miniport driver block 224. The virtual bus driver block 238 may comprise a plurality of drivers that facilitate the transfer of data between the software initiator block 222 and the hardware block 240. The virtual bus driver block 238 may be coupled to the TOE/RDMA block 228, NDIS miniport driver block 234, the sockets layer block 226, the other protocols block 236 and the hardware block 240. The other protocols block 236 may comprise suitable logic, circuitry and/or code that may implement various protocols, for example, the Fiber Channel Protocol (FCP) or the SCSI-3 protocol standard to implement serial SCSI over Fiber Channel networks. The hardware block 240 may comprise suitable logic and/or circuitry that may enable processing received of data from the drivers, the network interface and other devices coupled to the hardware block 240.

The initiator 118 [FIG. 1] and target 122 devices on a network may be named with a unique identifier and assigned an address for access. The initiators 118 and target nodes 122 may use an enterprise unique identifier (EUI). Each node may have an address comprised of the IP address, the TCP port number, and the EUI name. The IP address may be assigned by utilizing the same methods commonly employed on networks, such as dynamic host control protocol (DHCP) or manual configuration. During a discovery phase, the software initiator 222 or the miniport driver 224 may be able to determine or accept the IP address for the management layers WMI 210, initiator services 206, management interface libraries 204 and management utilities and agents 202 for both the storage resources available on a network, and whether or not access to that storage is permitted. For example, the address of a target portal may be manually configured and the initiator may establish a discovery session. The target device may respond by sending a complete list of additional targets that may be available to the initiator.

The Internet Storage Name Service (iSNS) is a device discovery protocol that may provide both naming and resource discovery services for storage devices on the IP network and builds upon both IP and Fibre Channel technologies. The protocol may utilize an iSNS server as a central location for tracking information about targets and initiators. The server may run on any host, target, or initiator on the network. The iSNS client software may be required in each host initiator or storage target device to enable communication with the server. In the initiator, the iSNS client may register the initiator and may query the list of targets. In the target, the iSNS client may register the target with the server.

For the initiator to transmit information to the target, the initiator may first establish a session with the target through a logon process. This process may start the TCP/IP connection, and verify that the initiator has access rights to the target through authentication. The initiator may authorize the target as well. The process may also allow negotiation of various parameters including the type of security protocol to be used, and the maximum data packet size. If the logon is successful, an ID may be assigned to both the initiator and the target. For example, an initiator session ID (ISID) may be assigned to the initiator and a target session ID (TSID) may be assigned to the target. Multiple TCP connections may be established between each initiator target pair, allowing more transactions during a session or redundancy and fail over in case one of the connections fails.

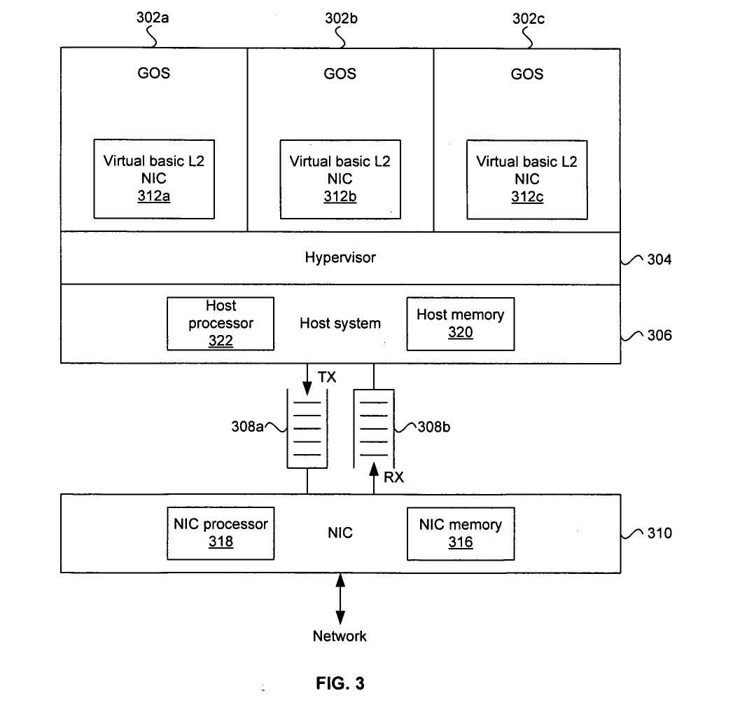

FIG. 3 is a block diagram of a NIC where a host system supports a plurality of GOSs, in connection with an embodiment of the invention. Referring to FIG. 3, there is shown a first GOS 302a, a second GOS 302b, a third GOS 302c, a hypervisor 304, a host system 306, a transmit (TX) queue 308a, a receive (RX) queue 308b, and a NIC 310. The NIC 310 may comprise a NIC processor 318 and a NIC memory 316. The host system 306 may comprise a host processor 322 and a host memory 320.

The host system 306 may comprise suitable logic, circuitry, and/or code that may enable data processing and/or networking operations, for example. In some instances, the host system 306 may also comprise other hardware resources such as a graphics card and/or a peripheral sound card, for example. The host system 306 may support the operation of the first GOS 302a, the second GOS 302b, and the third GOS 302c via the hypervisor 304. The number of GOSs that may be supported by the host system 306 by utilizing the hypervisor 304 need not be limited to the exemplary embodiment described in FIG. 3. For example, two or more GOSs may be supported by the host system 306.

The hypervisor 304 may operate as a software layer that may enable OS virtualization of hardware resources in the host system 306 and/or virtualization of hardware resources communicatively connected to the host system 306, such as the NIC 310, for example. The hypervisor 304 may also enable data communication between the GOSs and hardware resources in the host system 306 and/or hardware resources communicatively connected to the host system 306. For example, the hypervisor 304 may enable packet communication between GOSs supported by the host system 306 and the NIC 310 via the TX queue 308a and/or the RX queue 308b.

The host processor 322 may comprise suitable logic, circuitry, and/or code that may enable control and/or management of the data processing and/or networking operations associated with the host system 306. The host memory 320 may comprise suitable logic, circuitry, and/or code that may enable storage of data utilized by the host system 306. The host memory 320 may be partitioned into a plurality of memory portions. For example, each GOS supported by the host system 306 may have a corresponding memory portion in the host memory 320. Moreover, the hypervisor 304 may have a corresponding memory portion in the host memory 320. In this regard, the hypervisor 304 may enable data communication between GOSs by controlling the transfer of data from a portion of the memory 320 that corresponds to one GOS to another portion of the memory 320 that corresponds to another GOS.

The NIC 310 may comprise suitable logic, circuitry, and/or code that may enable communication of data with a network. The NIC 310 may enable basic level 2 (L2) switching operations, for example. The TX queue 308a may comprise suitable logic, circuitry, and/or code that may enable posting of data for transmission via the NIC 310. The RX queue 308b may comprise suitable logic, circuitry, and/or code that may enable posting of data received via the NIC 310 for processing by the host system 306. In this regard, the NIC 310 may post data received from the network in the RX queue 308b and may retrieve data posted by the host system 306 in the TX queue 308a for transmission to the network. The TX queue 308a and the RX queue 108b may be integrated into the NIC 110, for example. The NIC processor 318 may comprise suitable logic, circuitry, and/or code that may enable control and/or management of the data processing and/or networking operations in the NIC 310. The NIC memory 316 may comprise suitable logic, circuitry, and/or code that may enable storage of data utilized by the NIC 310.

The first GOS 302a, the second GOS 302b, and the third GOS 302c may each correspond to an operating system that may enable the running or execution of operations or services such as applications, email server operations, database server operations, and/or exchange server operations, for example. The first GOS 302a may comprise a virtual NIC 312a, the second GOS 302b may comprise a virtual NIC 312b, and the third GOS 302c may comprise a virtual NIC 312c. The virtual NIC 312a, the virtual NIC 312b, and the virtual NIC 312c may correspond to software representations of the NIC 310 resources, for example. In this regard, the NIC 310 resources may comprise the TX queue 308a and the RX queue 308b. Virtualization of the NIC 310 resources via the virtual NIC 312a, the virtual NIC 312b, and the virtual NIC 312c may enable the hypervisor 304 to provide L2 switching support provided by the NIC 310 to the first GOS 302a, the second GOS 302b, and the third GOS 302. In this instance, however, virtualization of the NIC 310 resources by the hypervisor 304 may not enable the support of other advanced functions such as TCP offload, iSCSI, and/or RDMA in a GOS.

In operation, when a GOS needs to send a packet to the network, the packet transmission may be controlled at least in part by the hypervisor 304. The hypervisor 304 may arbitrate access to the NIC 310 resources when more than one GOS needs to send a packet to the network. In this regard, the hypervisor 304 may utilize the virtual NIC to indicate to the corresponding GOS the current availability of NIC 310 transmission resources as a result of the arbitration. The hypervisor 304 may coordinate the transmission of packets from the GOSs by posting the packets in the TX queue 308a in accordance with the results of the arbitration operation. The arbitration and/or coordination operations that occur in the transmission of packets may result in added overhead to the hypervisor 304.

When receiving packets from the network via the NIC 310, the hypervisor 304 may determine the media access control (MAC) address associated with the packet in order to transfer the received packet to the appropriate GOS. In this regard, the hypervisor 304 may receive the packets from the RX queue 308b and may demultiplex the packets for transfer to the appropriate GOS. After a determination of the MAC address and appropriate GOS for a received packet, the hypervisor 304 may transfer the received packet from a buffer in the hypervisor portion of the host memory 320 to a buffer in the portion of the host memory 320 that corresponds to the appropriate GOS. The operations associated with receiving packets and transferring packets to the appropriate GOS may also result in added overhead to the hypervisor 304.

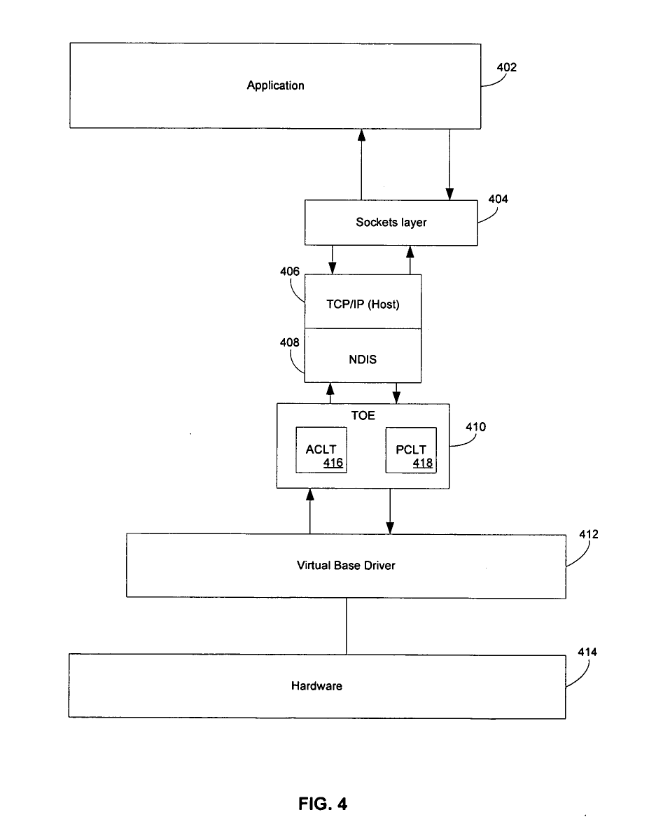

FIG. 4 is a block diagram illustrating offload of data from a host TCP processor to a TCP offload engine (TOE), in accordance with an embodiment of the invention. Referring to FIG. 4, there is shown an application layer block 402, a sockets layer block 404, a host TCP/IP block 406, a NDIS block 408, a TOE 410, a virtual bus driver block 412, and a hardware block 414. The TOE 410 may comprise a TCP active connection lookup table (ACLT) 416 and a TCP passive connection lookup table (PCLT) 418.

The application layer block 402 may comprise a plurality of functional blocks for applications services, for example, TCP/IP application protocols such as file transfer protocol (FTP), simple mail transfer protocol (SMTP), simple network management protocol (SNMP). Accelerated network adapters may be utilized to offload TCP overhead from a host processor to the network adapter. The sockets layer block 404 may be adapted to interface with the hardware 414 capable of supporting TCP offload. For non-offloaded TCP communication, the host TCP/IP stack block 406 may utilize transmission control protocol/internet protocol that may be adapted to provide communication across interconnected networks. The network driver interface specification NDIS block 408 may comprise a device-driver specification that may be adapted to provide hardware and protocol independence for network drivers and offer protocol multiplexing so that multiple protocol stacks may coexist on the same host. The NDIS block 408 may comprise routines that may be utilized to interface with the storage adapter's hardware and may be coupled to the virtual bus driver (VBD) block 412. The VBD block 412 may be required in order to simplify the hardware's 414 system interface and internal handling of requests from multiple stacks on the host.

The virtual bus driver block 412 may comprise a plurality of drivers, which may facilitate the transfer of data between the TOE 410 and the hardware block 414. The hardware block 414 may comprise suitable logic and/or circuitry that may enable processing of received data from the drivers and other devices coupled to the hardware block 414.

The TOE 410 may comprise suitable logic, circuitry and/or code that may be adapted to implement remote direct memory access that may allow data to be transmitted from the memory of one computer to the memory of another computer without passing through either device's central processing unit (CPU). In this regard, extensive buffering and excessive calls to an operating system kernel may not be necessary. The TOE 410 may be coupled to the virtual bus driver block 412 and the host TCP block 406. The TOE 410 may comprise a TCP active connection lookup table (ACLT) 416 and a TCP passive connection lookup table (PCLT) 418. The TCP active connection lookup table (ACLT) 416 and the TCP passive connection lookup table (PCLT) 418 may be accessed using a tuple, for example, source IP address, destination IP address, source TCP port and destination TCP port.

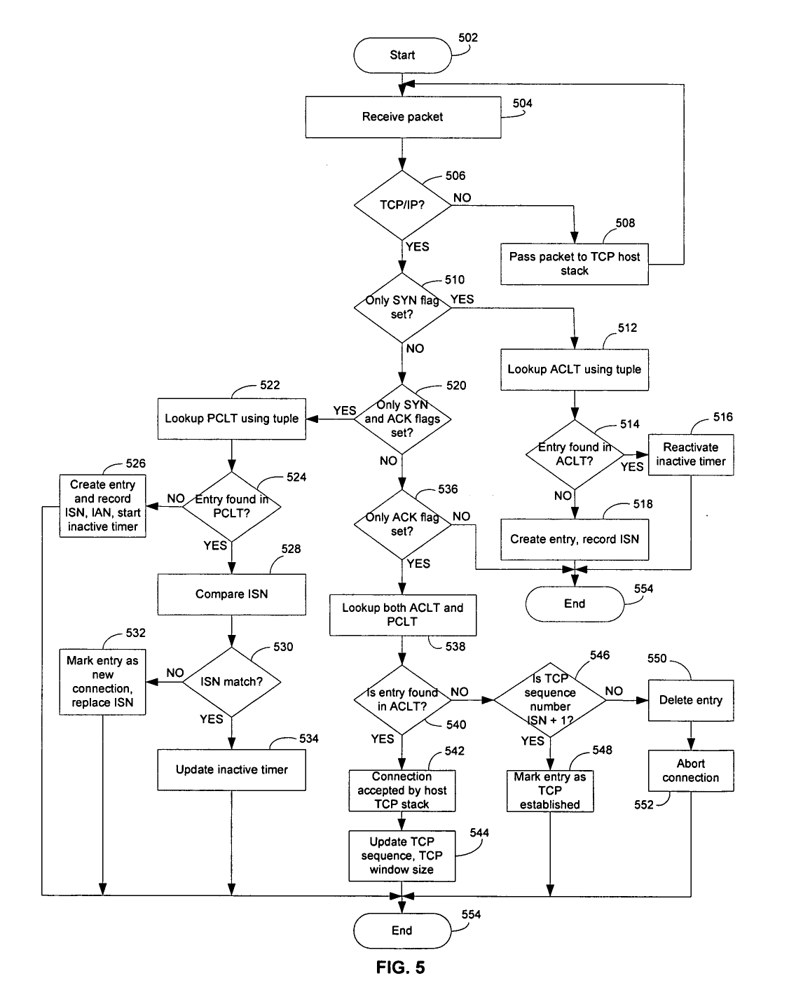

FIG. 5 is a flowchart illustrating TCP offload during transmission of packets from host TCP stack, in accordance with an embodiment of the invention. Referring to FIG. 5, exemplary steps may start at step 502. In step 504, the TCP offload engine may receive a packet from the host TCP stack. In step 506, it may be determined whether the received packet is a TCP/IP packet. If the received packet is not a TCP/IP packet, control passes to step 508. In step 508, the received packet is passed to the TCP host stack for further processing. Control passes to step 504. If the received packet is a TCP/IP packet, control passes to step 510. In step 510, it may be determined whether only a control bit, SYN is set. The control bit SYN may occupy one sequence number, used at the initiation of the connection, to indicate where the sequence numbering will start. If only the control bit SYN is set, control passes to step 512. In step 512, a TCP active connection lookup table (ACLT) may be accessed using a tuple, for example, source IP address, destination IP address, source TCP port and destination TCP port. In step 514, it may be determined whether the received packet matches an entry in the ACLT table. If the received packet matches an entry in the ACLT table, control passes to step 516. In step 516, an inactive timer may be reactivated. The timer may determine when the ACLT table was last referenced. If the received packet matches an entry in the ACLT, the received packet may be a retransmit, and the previous table entry may be purged. Control then passes to end step 554. If the received packet does not match with an entry in the ACLT table, control passes to step 518. In step 518, a new entry may be created in the ACLT table. The initial sequence number (ISN) of the received packet may be recorded and the entry may be marked as a TCP SYN received state. Control then passes to end step 554. In step 510, if only the control bit SYN is not set, control passes to step 520.

In step 520, it may be determined whether both control bit SYN and an acknowledge (ACK) flag are set. If both the control bit SYN and an acknowledge (ACK) flag are set, control passes to step 522. In step 522, a TCP passive connection lookup table (PCLT) may be accessed using a tuple, for example, source IP address, destination IP address, source TCP port and destination TCP port. In step 524, it may be determined whether the received packet matches with an entry in the PCLT table. If the received packet does not match with an entry in the PCLT table, control passes to step 526. In step 526, a new entry may be created in the PCLT table. The initial sequence number (ISN), the initial acknowledgement number (IAN), TCP window size, and the TCP maximum segment size (MSS) may be recorded. The inactive timer may be started and the entry may be marked as TCP SYN received state. Control then passes to end step 554. If the received packet matches with an entry in the PCLT table, control passes to step 528. In step 528, the ISN of the received packet may be compared with entries in the PCLT table. In step 530, it may be determined whether there is a match between the ISN of the received packet and one of the entries in the PCLT table. If a match exists between the ISN of the received packet and one of the entries in the PCLT table, control passes to step 534. In step 534, the inactive timer may be updated. Control then passes to end step 554. If a match does not exist between the ISN of the received packet and one of the entries in the PCLT table, control passes to step 532. In step 532, the received packet may be marked as a new connection in the PCLT table. The ISN may be replaced with the ISN of the received packet and the entry may be marked as TCP SYN received state. Control then passes to end step 554. In step 520, if both the control bit SYN and an acknowledge (ACK) flag are not set, control passes to step 536.

In step 536, it may be determined whether only the ACK flag is set in the received packet. If only the ACK flag is not set in the received packet, control passes to end step 554. If only the ACK flag is set in the received packet, control passes to step 538. In step 538, both the ACLT and PCLT may be accessed using a tuple, for example, source IP address, destination IP address, source TCP port and destination TCP port. In step 540, it may be determined whether the received packet matches with an entry in the ACLT table. If the received packet matches with an entry in the ACLT table and the entry is marked as a TCP SYN received state, control passes to step 542. In step 542, the connection is accepted by the host TCP stack. The entry in the ACLT table may be marked as a TCP established state. In step 544, the TCP sequence may be updated by incrementing the ISN. The TCP window size and the TCP maximum segment size may be updated in the ACLT table. Control then passes to end step 554. If the received packet does not match with an entry in the ACLT table and the entry is marked as a TCP SYN received state, control passes to step 546. In step 546, the entry matches an entry in the PCLT table and it may be determined whether the TCP sequence number has been updated by incrementing the ISN. If the entry matches an entry in the PCLT table, and the TCP sequence number has been updated by incrementing the ISN, control passes to step 548. In step 548, the entry may be marked as TCP established in the PCLT table. Control then passes to end step 554. If the entry matches an entry in the PCLT table, and the TCP sequence number has not been updated by incrementing the ISN, control passes to step 550. In step 550, the corresponding entry in the PCLT table may be deleted. In step 552, the connection may be aborted. Control then passes to end step 554.

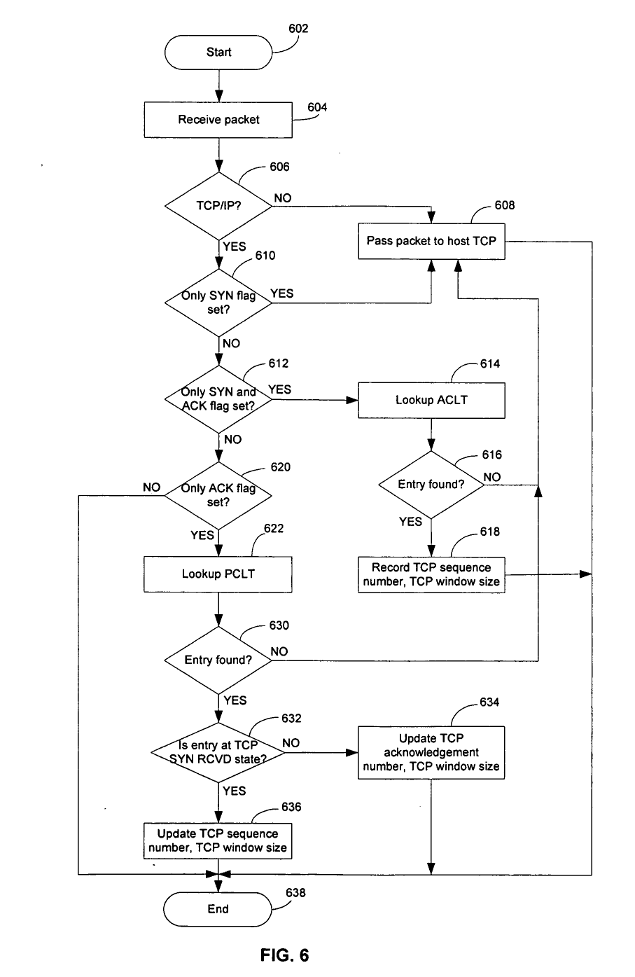

FIG. 6 is a flowchart illustrating TCP offload during receipt of packets by host TCP stack, in accordance with an embodiment of the invention. Referring to FIG. 6, exemplary steps may start at step 602. In step 604, the TCP offload engine may receive a packet to be transmitted to the host TCP stack. In step 606, it may be determined whether the received packet is a TCP/IP packet. If the received packet is not a TCP/IP packet, control passes to step 608. In step 608, the received packet is passed to the TCP host stack for further processing. Control passes to end step 638. If the received packet is a TCP/IP packet, control passes to step 610. In step 610, it may be determined whether only a control bit, SYN is set. The control bit SYN may occupy one sequence number, used at the initiation of the connection, to indicate where the sequence numbering will start. If only the control bit SYN is set, control passes to step 608. In step 608, the received packet is passed to the TCP host stack for further processing. Control passes to end step 638. If only the control bit SYN is not set, control passes to step 612.

In step 612, it may be determined whether both control bit SYN and an acknowledge (ACK) flag are set. If both the control bit SYN and an acknowledge (ACK) flag are set, control passes to step 614. In step 614, a TCP active connection lookup table (ACLT) may be accessed using a tuple, for example, source IP address, destination IP address, source TCP port and destination TCP port. In step 616, it may be determined whether the received packet matches with an entry in the ACLT table. If the received packet does not match an entry in the ACLT table, control passes to step 608. In step 608, the received packet is passed to the TCP host stack for further processing. Control passes to end step 638. If the received packet matches an entry in the ACLT table, control passes to step 618. In step 618, the TCP sequence number, the TCP window size, and the TCP maximum segment size (MSS) may be recorded. Control then passes to end step 638. In step 612, if both the control bit SYN and an acknowledge (ACK) flag are not set, control passes to step 620.

In step 620, it may be determined whether only the ACK flag is set in the received packet. If only the ACK flag is not set in the received packet, control passes to end step 638. If only the ACK flag is set in the received packet, control passes to step 622. In step 622, the PCLT may be accessed using a tuple, for example, source IP address, destination IP address, source TCP port and destination TCP port. In step 630, it may be determined whether the received packet matches an entry in the ACLT table. If the received packet does not match with an entry in the ACLT table, control passes to step 608. In step 608, the received packet is passed to the TCP host stack for further processing. Control passes to end step 638. If the received packet matches an entry in the ACLT table, control passes to step 632. In step 632, it may be determined whether the received packet is marked as a TCP SYN received state in the PCLT table. If the received packet is marked as a TCP SYN received state in the PCLT table, control passes to step 636. In step 636, the TCP sequence and TCP window size may be updated in the PCLT table. Control then passes to end step 638. If the received packet is not marked as a TCP SYN received state in the PCLT table, control passes to step 634. In step 634, the TCP acknowledgement number and TCP window size may be updated in the PCLT table. Control then passes to end step 638.

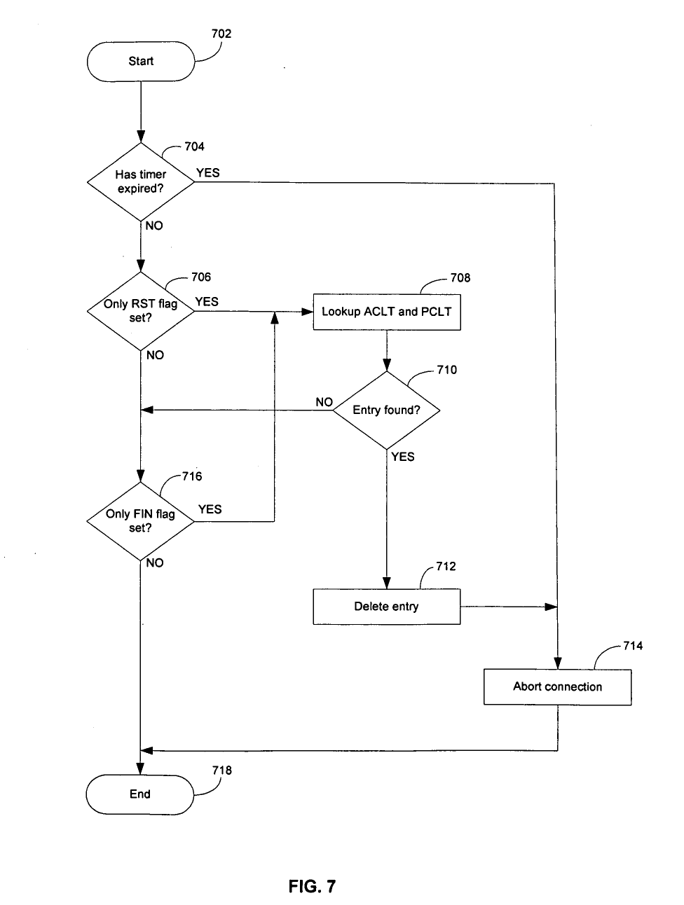

FIG. 7 is a flowchart illustrating termination of a TCP offload connection, in accordance with an embodiment of the invention. Referring to FIG. 7, exemplary steps may start at step 702. A timer may determine when the ACLT table or the PCLT table was last referenced and may record the duration of a TCP offload connection. In step 704, it may be determined whether the timer has expired. If the timer has expired, control passes to step 714. In step 714, the TCP offload connection may be aborted. Control passes to end step 718. If the timer has not expired, control passes to step 706.

In step 706, it may be determined whether only the reset (RST) flag has been set in the received packet. If only the reset (RST) flag has been set in the received packet, control passes to step 708. In step 708, both the ACLT and PCLT tables may be accessed using a tuple, for example, source IP address, destination IP address, source TCP port and destination TCP port. In step 710, it may be determined whether the received packet matches with an entry in either the ACLT table or the PCLT table. If the received packet matches an entry in the ACLT table or the PCLT table, control passes to step 712. In step 712, the corresponding entry in the ACLT table or the PCLT table may be deleted. In step 714, the TCP offload connection may be aborted. Control passes to end step 718. If the received packet does not match an entry in the ACLT table or the PCLT table, control passes to step 716.

In step 716, it may be determined whether a control bit finish (FIN) is set in the received packet. The control bit FIN may occupy one sequence number, which may indicate that the sender may not send any more data or control occupying sequence space. If the control bit finish (FIN) is set in the received packet, control passes to step 708. In step 708, both the ACLT and PCLT tables may be accessed using a tuple, for example, source IP address, destination IP address, source TCP port and destination TCP port. In step 710, it may be determined whether the received packet matches an entry in either the ACLT table or the PCLT table. If the received packet matches an entry in the ACLT table or the PCLT table, control passes to step 712. In step 712, the corresponding entry in the ACLT table or the PCLT table may be deleted. In step 714, the TCP offload connection may be aborted. Control passes to end step 718. If the control bit finish (FIN) is not set in the received packet, control passes to end step 718.

In an embodiment of the invention, the TCP processing of packets of data may be offloaded to the TCP offload engine by deducing TCP states by accessing an initial exchange of the TCP frame. The host TCP stack may manage the TCP connection setup and may offload the TCP state to the TCP offload engine. The host TCP stack may need to give only one bit to transfer the TCP connection ownership. The overhead of the offload and the latency may be reduced by transferring the TCP connection ownership.

Another embodiment of the invention may provide a machine-readable storage, having stored thereon, a computer program having at least one code section executable by a machine, thereby causing the machine to perform the steps as described above for a one bit TCP offload.

In an embodiment of the invention, a system for processing data via a transmission control protocol (TCP) offload engine may comprise at least one processor, for example, the network interface card (NIC) processor 318 that enables initiation of offload processing of TCP data based on assertion of at least one bit without receiving TCP connection state information from a host, for example, host processor 322. The NIC processor 318 enables determining whether said asserted said at least one bit is at least one of: a synchronous (SYN) control bit and an acknowledgement (ACK) bit in a received packet of data. The NIC processor 318 enables checking a TCP active connection lookup table (ACLT) 416 utilizing at least one of: a source IP address, a destination IP address, a source TCP port, and a destination TCP port to determine whether the received packet of data comprising the asserted SYN control bit matches an entry in the ACLT 416.

The NIC processor 318 enables reactivation of a timer if the received packet of data comprising the asserted SYN control bit matches an entry in the ACLT 416. The NIC processor 318 enables creation of a new entry in the ACLT 416 by recording an initial sequence number (ISN) of the received packet of data, if the received packet of data comprising the asserted SYN control bit does not match an entry in the ACLT 416. The NIC processor 318 enables checking a TCP passive connection lookup table (PCLT) 418 utilizing at least one of: a source IP address, a destination IP address, a source TCP port, and a destination TCP port to determine whether the received packet of data comprising the asserted SYN control bit and the asserted ACK bit matches an entry in the PCLT 418. The NIC processor 318 enables comparing an initial sequence number (ISN) of the received packet of data with the matched entry in the PCLT 418, if the received packet of data comprising the asserted SYN control bit and the asserted ACK bit matches the entry in the PCLT 418. The NIC processor 318 enables updating a timer if the ISN of the received packet of data matches the matched entry in the PCLT 418. The NIC processor 318 enables creating a new entry in the PCLT 418 by recording the ISN of the received packet of data, if the ISN of the received packet of data does not match the matched entry in the PCLT 418. The NIC processor 318 enables creating a new entry in the PCLT 418 by recording at least one of: the ISN and an initial acknowledgement number (IAN) of the received packet of data, if the received packet of data comprising the asserted SYN control bit and the asserted ACK bit does not match the entry in the PCLT 418.

The NIC processor 318 enables checking at least one of: a TCP active connection lookup table (ACLT) 416 and a TCP passive connection lookup table (PCLT) 418 utilizing at least one of: a source IP address, a destination IP address, a source TCP port, and a destination TCP port to determine whether the received packet of data comprising the asserted ACK bit matches an entry in at least one of: the ACLT 416 and said PCLT 418. The NIC processor 318 enables updating at least one of: a TCP sequence and a TCP window size of the received packet of data, if the received packet of data comprising the asserted ACK bit matches the entry in the ACLT 416. The NIC processor 318 enables deletion of the entry in the PCLT 418, if a TCP sequence number of said received packet of data is not incremented and if said received packet of data comprising the asserted ACK bit matches the entry in the PCLT 418. The NIC processor 318 enables offload processing of the TCP data to the TCP offload engine 410 in response to receiving at least one bit of data from the host processor 322, if a TCP sequence number of the received packet of data is incremented and if the received packet of data comprising the asserted ACK bit matches the entry in the PCLT 418. The NIC processor 318 enables termination of the offload processing of the TCP data to the TCP offload engine 410, if at least one of: a reset (RST) control bit and a finish (FIN) control bit is asserted in a received packet of data.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing data via a transmission control protocol (TCP) offload engine, the method comprising initiating offload processing of TCP data based on assertion of at least one bit without receiving TCP connection state information from a host.

2. The method according to claim 1, further comprising determining whether said asserted said at least one bit is at least one of: a synchronous (SYN) control bit and an acknowledgement (ACK) bit in a received packet of data.

3. The method according to claim 2, further comprising checking a TCP active connection lookup table (ACLT) utilizing at least one of: a source IP address, a destination IP address, a source TCP port, and a destination TCP port to determine whether said received packet of data comprising said asserted SYN control bit matches an entry in said ACLT.

4. The method according to claim 3, further comprising reactivating a timer if said received packet of data with said asserted SYN control bit matches an entry in said ACLT.

5. The method according to claim 3, further comprising if said received packet of data with said asserted SYN control bit does not match an entry in said ACLT, creating a new entry in said ACLT by recording a initial sequence number (ISN) of said received packet of data.

6. The method according to claim 2, further comprising checking a TCP passive connection lookup table (PCLT) utilizing at least one of: a source IP address, a destination IP address, a source TCP port, and a destination TCP port to determine whether said received packet of data with said asserted SYN control bit and said asserted ACK bit matches an entry in said PCLT.

7. The method according to claim 6, further comprising if said received packet of data with said asserted SYN control bit and said asserted ACK bit matches said entry in said PCLT, comparing an initial sequence number (ISN) of said received packet of data with said matched entry in said PCLT.

8. The method according to claim 7, further comprising updating a timer if said ISN of said received packet of data matches said matched entry in said PCLT.

9. The method according to claim 7, further comprising if said ISN of said received packet of data does not match said matched entry in said PCLT, creating a new entry in said PCLT by recording said ISN of said received packet of data.

10. The method according to claim 6, further comprising if said received packet of data with said asserted SYN control bit and said asserted ACK bit does not match said entry in said PCLT, creating a new entry by recording at least one of: said ISN and an initial acknowledgement number (IAN) of said received packet of data in said PCLT.

11. The method according to claim 2, further comprising checking at least one of: a TCP active connection lookup table (ACLT) and a TCP passive connection lookup table (PCLT) utilizing at least one of: a source IP address, a destination IP address, a source TCP port, and a destination TCP port to determine whether said received packet of data comprising said asserted ACK bit matches an entry in at least one of: said ACLT and said PCLT.

12. The method according to claim 11, further comprising if said received packet of data with said asserted ACK bit matches said entry in said ACLT, updating at least one of: a TCP sequence and a TCP window size of said received packet of data.

13. The method according to claim 11, further comprising if said received packet of data comprising said asserted ACK bit matches said entry in said PCLT, deleting said entry in said PCLT if a TCP sequence number of said received packet of data is not incremented.

14. The method according to claim 11, further comprising if said received packet of data comprising said asserted ACK bit matches said entry in said PCLT, offload processing of said TCP data to said TCP offload engine in response to said receiving said at least one bit of data from said host, if a TCP sequence number of said received packet of data is incremented.

15. The method according to claim 1, further comprising terminating said offload processing of said TCP data to said TCP offload engine, if at least one of: a reset (RST) control bit and a finish (FIN) control bit is asserted in a received packet of data.

16. A system for processing data via a transmission control protocol (TCP) offload engine, the system comprising at least one processor that enables initiation of offload processing of TCP data based on assertion of at least one bit without receiving TCP connection state information from a host.

17. The system according to claim 16, wherein said at least one processor enables determining whether said asserted said at least one bit is at least one of: a synchronous (SYN) control bit and an acknowledgement (ACK) bit in a received packet of data.

18. The system according to claim 17, wherein said at least one processor enables checking a TCP active connection lookup table (ACLT) utilizing at least one of: a source IP address, a destination IP address, a source TCP port, and a destination TCP port to determine whether said received packet of data comprising said asserted SYN control bit matches an entry in said ACLT.

19. The system according to claim 18, wherein said at least one processor enables reactivation of a timer if said received packet of data with said asserted SYN control bit matches an entry in said ACLT.

20. The system according to claim 18, wherein said at least one processor enables creation of a new entry in said ACLT by recording a initial sequence number (ISN) of said received packet of data, if said received packet of data comprising said asserted SYN control bit does not match an entry in said ACLT.

21. The system according to claim 17, wherein said at least one processor enables checking a TCP passive connection lookup table (PCLT) utilizing at least one of: a source IP address, a destination IP address, a source TCP port, and a destination TCP port to determine whether said received packet of data with said asserted SYN control bit and said asserted ACK bit matches an entry in said PCLT.

22. The system according to claim 21, wherein said at least one processor enables comparing an initial sequence number (ISN) of said received packet of data with said matched entry in said PCLT, if said received packet of data with said asserted SYN control bit and said asserted ACK bit matches said entry in said PCLT.

23. The system according to claim 22, wherein said at least one processor enables updating a timer if said ISN of said received packet of data matches said matched entry in said PCLT.

24. The system according to claim 22, wherein said at least one processor enables creating a new entry in said PCLT by recording said ISN of said received packet of data, if said ISN of said received packet of data does not match said matched entry in said PCLT.

25. The system according to claim 21, wherein said at least one processor enables creating a new entry in said PCLT by recording at least one of: said ISN and an initial acknowledgement number (IAN) of said received packet of data, if said received packet of data comprising said asserted SYN control bit and said asserted ACK bit does not match said entry in said PCLT.

26. The system according to claim 17, wherein said at least one processor enables checking at least one of: a TCP active connection lookup table (ACLT) and a TCP passive connection lookup table (PCLT) utilizing at least one of: a source IP address, a destination IP address, a source TCP port, and a destination TCP port to determine whether said received packet of data comprising said asserted ACK bit matches an entry in at least one of: said ACLT and said PCLT.

27. The system according to claim 26, wherein said at least one processor enables updating at least one of: a TCP sequence and a TCP window size of said received packet of data, if said received packet of data comprising said asserted ACK bit matches said entry in said ACLT.

28. The system according to claim 26, wherein said at least one processor enables deletion of said entry in said PCLT, if a TCP sequence number of said received packet of data is not incremented and if said received packet of data comprising said asserted ACK bit matches said entry in said PCLT.

29. The system according to claim 26, wherein said at least one processor enables offload processing of said TCP data to said TCP offload engine in response to said receiving said at least one bit of data from said host, if a TCP sequence number of said received packet of data is incremented and if said received packet of data comprising said asserted ACK bit matches said entry in said PCLT.

30. The system according to claim 16, wherein said at least one processor enables termination of said offload processing of said TCP data to said TCP offload engine, if at least one of: a reset (RST) control bit and a finish (FIN) control bit is asserted in a received packet of data.
